(19) United States
(12) Patent Application Publication
(10) Pub. No.: US 2016/0338077 A1
(43) Pub. Date: Nov. 17, 2016

(54) TRANSMITTER SHARING SYSTEM FOR DUAL ACTIVE SUBSCRIPTIONS

(71) Applicant: QUALCOMM Incorporated, San Diego, CA (US)

(72) Inventors: Tom CHIN, San Diego, CA (US); Thawatt GOPAL, San Diego, CA (US)

(21) Appl. No.: 14/714,172

(22) Filed: May 15, 2015

(51) Int. Cl. H04W 72/10; H04W 72/04

(52) U.S. Cl. CPC H04W 72/10; H04W 72/0413

(57) ABSTRACT

For a user equipment in a transmitter sharing dual subscriber identity module (SIM) dual active subscriptions (DSDA) mode, a first subscription of a first radio access technology (RAT) in a packet switched data call in general has a lower priority than a second subscription in an active voice call in a second RAT. As a result of this default high priority assigned to the active voice call, the first subscription may experience long delay, low throughput or in some cases radio link failure due to long starvations. A method for wireless communication includes detecting whether an uplink transmission within a frame of the second RAT overlaps at least one time slot of the first RAT. The method also includes prioritizing data of the first RAT by blanking the frame of the second RAT when a number of overlapping slots is above a threshold.

### BACKGROUND

1. Field

Aspects of the present disclosure relate generally to wireless communication systems, and more particularly, to a transmitting sharing system for dual active subscriptions.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is long term evolution (LTE) or its variant time division LTE (TD-LTE). LTE is a set of enhancements to the universal mobile telecommunications system (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### SUMMARY

In an aspect of the present disclosure, a method of wireless communication in a multi subscriber identification module (SIM) user equipment (UE) with multiple active subscriptions sharing a transmit (TX) chain among at least a first radio access technology (RAT) and a second RAT is presented. The method includes detecting whether an uplink transmission within a frame of the second RAT overlaps with at least one time slot of the first RAT. The method also includes prioritizing data of the first RAT by blanking the frame of the second RAT when a number of overlapping slots is above a threshold.

In another aspect of the present disclosure, an apparatus for wireless communication has multiple active subscriptions sharing a transmit (TX) chain among at least a first radio access technology (RAT) and a second RAT. The apparatus includes a memory and at least one processor coupled to the memory. The processor(s) is configured to detect whether an uplink transmission within a frame of the second RAT overlaps at least one time slot of the first RAT. The processor(s) is further configured to prioritize data of the first RAT by blanking the frame of the second RAT when a number of overlapping slots is above a threshold.

In yet another aspect of the present disclosure, an apparatus for wireless communication has multiple active subscriptions sharing a transmit (TX) chain among at least a first radio access technology (RAT) and a second RAT. The apparatus includes means for detecting whether an uplink transmission within a frame of the second RAT overlaps at least one time slot of the first RAT. The apparatus further includes means for prioritizing data of the first RAT by blanking the frame of the second RAT when a number of overlapping slots is above a threshold.

In still another aspect of the present disclosure, a computer program product for wireless communication in a multi subscriber identification module (SIM) user equipment (UE) with multiple active subscriptions sharing a transmit (TX) chain among at least a first radio access technology (RAT) and a second RAT is presented. The computer program product includes a non-transitory computer readable medium having encoded thereon program code. The program code includes program code to detect whether an uplink transmission within a frame of the second RAT overlaps at least one time slot of the first RAT. The program code also includes program code to prioritize data of the first RAT by blanking the frame of the second RAT when a number of overlapping slots is above a threshold.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a user equipment (UE) in a telecommunications system.

FIG. 4 is a block diagram illustrating an example of blanking a vocoder frame according to one aspect of the present disclosure.

FIG. 5 is a block diagram illustrating an example of blanking packet data slots according to one aspect of the present disclosure.

FIG. 6 is a flow diagram illustrating an example of a decision process for sharing a transmitter for dual active subscriptions according to one aspect of the present disclosure.

FIG. 7 is a flow diagram illustrating a method for sharing a transmitter for dual active subscriptions according to one aspect of the present disclosure.

FIG. 8 is a block diagram illustrating different modules/means/components for sharing a transmitter for dual active subscriptions in an example apparatus according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

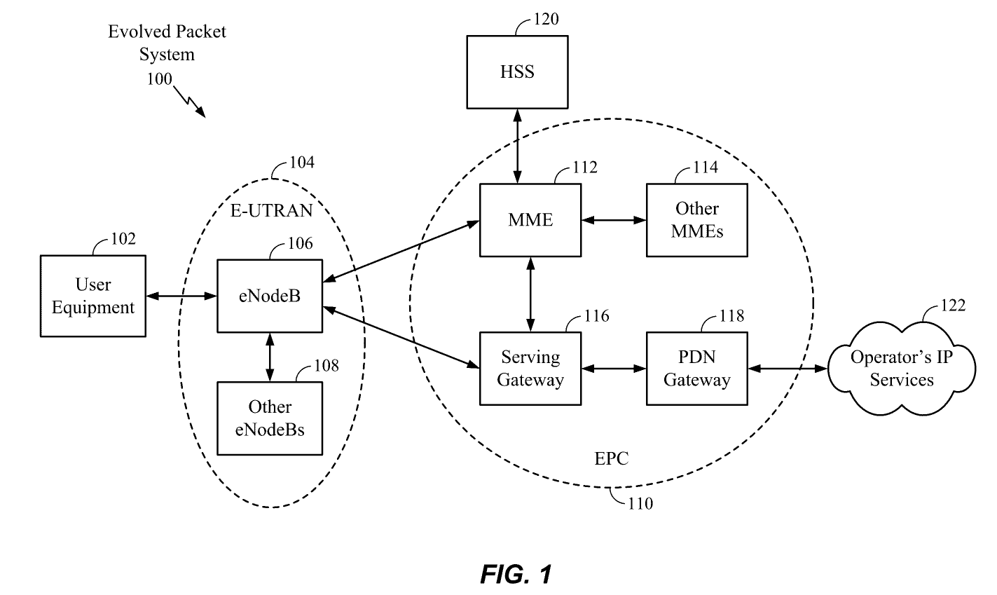

FIG. 1 is a diagram illustrating an LTE network architecture 100. The LTE network architecture 100 may be referred to as an evolved packet system (EPS) 100. The EPS 100 may include one or more user equipment (UE) 102, an evolved UMTS terrestrial radio access network (E-UTRAN) 104, an evolved packet core (EPC) 110, a home subscriber server (HSS) 120, and an operator's IP services 122. The EPS can interconnect with other access networks, but for simplicity those entities/interfaces are not shown. As shown, the EPS 100 provides packet-switched services, however, as those skilled in the art will readily appreciate, the various concepts presented throughout this disclosure may be extended to networks providing circuit-switched services.

The E-UTRAN 104 includes an evolved Node B (eNodeB) 106 and other eNodeBs 108. The eNodeB 106 provides user and control plane protocol terminations toward the user equipment (UE) 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an S1 interface. The EPC 110 includes a mobility management entity (MME) 112, other MMEs 114, a serving gateway 116, and a packet data network (PDN) gateway 118. The MME 112 is the control node that processes the signaling between the UE 102 and the EPC 110. Generally, the MME 112 provides bearer and connection management. All user IP packets are transferred through the serving gateway 116, which itself is connected to the PDN gateway 118. The PDN gateway 118 provides UE IP address allocation as well as other functions. The PDN gateway 118 is connected to the operator's IP services 122. The operator's IP services 122 may include the Internet, the Intranet, an IP multimedia subsystem (IMS), and a PS streaming service (PSS).

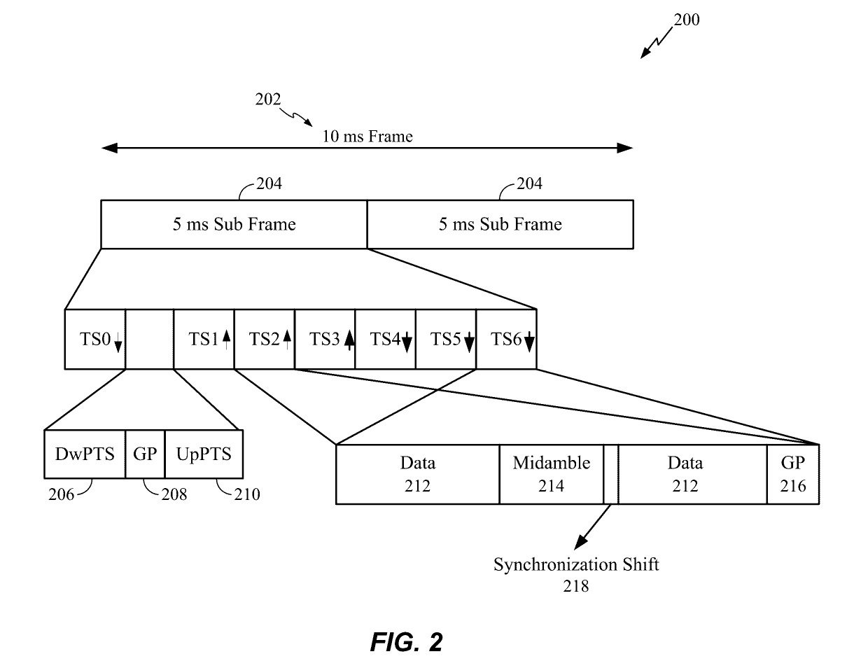

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including synchronization shift (SS) bits 218. Synchronization shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

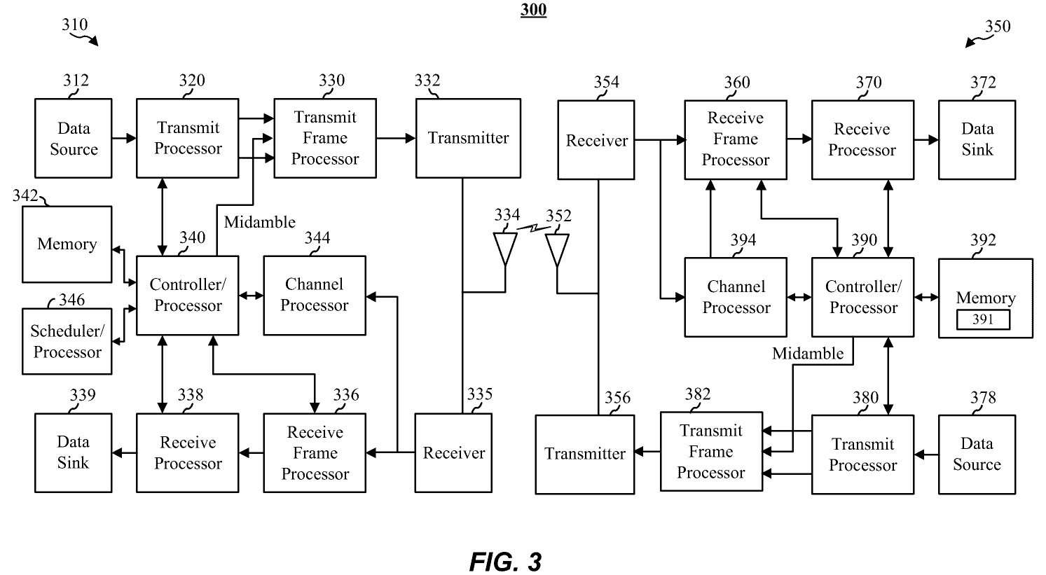

FIG. 3 is a block diagram of a node B 310 in communication with a UE 350 in a RAN 300, where the RAN 300 may be the E-UTRAN 104 in FIG. 1, the node B 310 may be the eNode B 106 in FIG. 1, and the UE 350 may be the UE 102 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames. Additionally, a scheduler/processor 346 at the node B 310 may be used to allocate resources to the UEs and schedule downlink and/or uplink transmissions for the UEs.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B 310 and the UE 350, respectively. For example, the memory 392 of the UE 350 may store an uplink transmitter sharing module 391, which, when executed by the controller/processor 390, configures the UE 350 for sharing a transmitter at a UE with dual active subscriptions.

The UE may include more than one subscriber identity module (SIM) or universal subscriber identity module (USIM). Each SIM may include a unique international mobile subscriber identity (IMSI) and service subscription information. Each SIM may be configured to operate in particular radio access technologies (e.g., LTE/TD-SCDMA/GSM/WCDMA). Each subscriber identity module may be associated with a same or different service provider or operator. Moreover, each subscriber identity module may have full phone features and may be associated with a unique phone number. Therefore, the UE may use each subscriber identity module to send and receive phone calls. That is, the UE may simultaneously communicate via the phone numbers associated with each individual subscriber identity module.

Multiple antennas and/or receivers/transmitters may be provided to facilitate multimode communication with various combinations of antenna and receiver/transmitter configurations. Each radio technology may transmit or receive signals via one or more antennas. For example, in some modem systems, there are two receivers for active radio access technologies. In other systems, there is only a single transmitter shared among multiple subscriptions.

A dual SIM device, equipped with more than one subscriber identity module may simultaneously access more than one core network, of the same or different radio access technologies such as global system for mobile communications (GSM), long term evolution, 1× radio transmission technology (1×)), global navigation satellite system (GNSS), evolution data optimized (EV-DO) or any other cellular technology, wideband code division multiple access (WCDMA), and time division-synchronous code division multiple access (TD-SCDMA). The dual SIM device may make a voice or data call through one of the RATs using either of the subscriber identity modules. Moreover, the dual SIM device may receive a phone call with either subscriber identity module from a calling party.

As noted, a user equipment that incorporates multi SIM devices or a single SIM device may occasionally perform measurements of neighbor cells of one or more RATs. To perform the measurements, however, idle time slots are identified for the serving RAT. When the idle time slots are insufficient for the measurement, some uplink and/or downlink time slots carrying information (e.g., data) are dropped to create sufficient idle time slots for the measurements. For example, to handover a communication from the first RAT (e.g., TD-SCDMA/LTE/WCDMA) to the second RAT (GSM) on a same or different receive chain, idle time slots of the first RAT are identified or created by dropping uplink and/or downlink information in some time slots of the first RAT. Dropping uplink and/or downlink information in some time slots of the first RAT to create the idle time slots (e.g., consecutive idle time slots) reduces the uplink and downlink throughput and degrades the quality of service of the communication system.

Transmitter Sharing with Multiple Active Subscriptions

For a UE in a transmitter sharing dual SIM dual active subscriptions (DSDA) mode, the subscription in an active voice call in general has a higher priority. Therefore, if a first subscription of a first RAT, such as LTE, TD-LTE, or TD-SCDMA, is in a packet switched data call and a second subscription of a second RAT, such as GSM, is in an active voice call, then, the uplink transmission activities of the second subscription have a higher priority over the first subscription. This may cause uplink transmission activities of the first subscription to be blanked, resulting in a low throughput or in some cases radio link failure of the first subscription due to long starvations.

According to one aspect of the present disclosure, a UE in the transmitter sharing DSDA mode may prioritize packet data time slots of the first radio access technology (RAT) instead of blindly prioritizing voice frames. The prioritization is effected by blanking voice vocoder (voice encoder) frames of the second RAT if the number of time slots in the vocoder frame overlapping the packet data time slots is above a threshold. This prioritization allows packet data transmissions to go through. Otherwise, if the number of overlapping time slots is not above the threshold, the UE may blank the packet data time slots to allow voice vocoder frames to go through.

According to another aspect of the present disclosure, the UE may adjust the threshold based on a vocoder frame type of the second RAT, a length of the packet data buffer of the first RAT, or both. The vocoder frame type may indicate how sensitive the vocoder frame of the second RAT is to transmission delay. For example, some vocoder frames are generated during silent periods. These frame types may be lower priority than frames generated during actual voice traffic. The length of the packet data buffer may indicate how much uplink packet data of the first RAT is waiting to be transmitted.

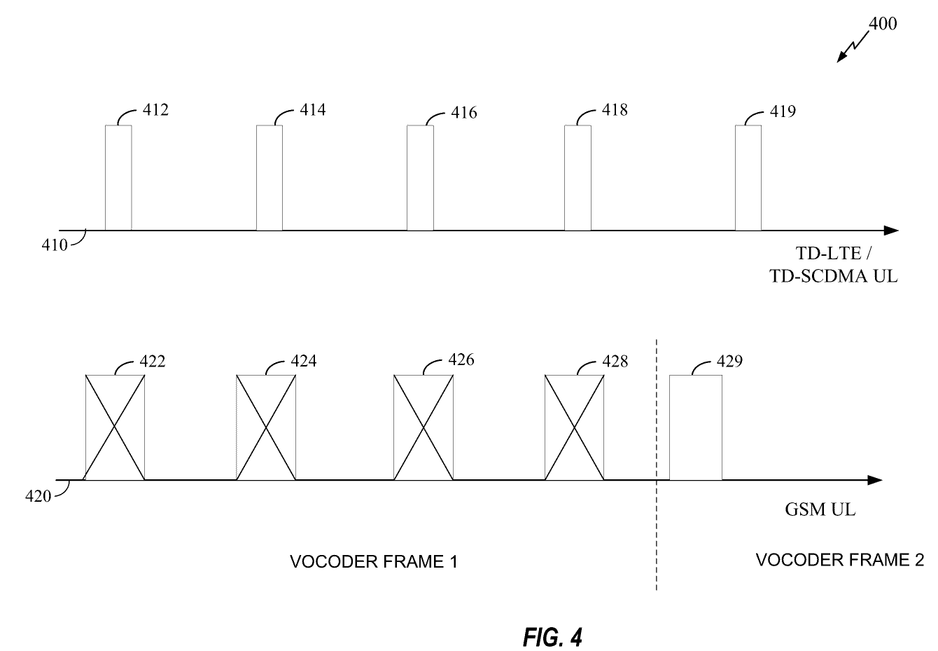

FIG. 4 is a block diagram illustrating an example 400 of blanking a vocoder frame of the second RAT. In this example, the number of time slots of the vocoder frame overlapping time slots of the first RAT is above a threshold. In FIG. 4, the x-axis represents time. The processing occurs within a UE having a single transmitter and multiple receivers. In this example, the UE may have two active subscriptions at the same time. The first subscription 410, also referred to as the first subscriber identity module (SIM), operates on a first radio access technology (RAT) such as TD-LTE or TD-SCDMA. The second subscription 420, or a second SIM, operates on a second RAT, such as GSM. In this example, both the subscriptions 410 and 420 may be operating simultaneously using a single shared transmitter on uplink transmissions and multiple receivers on the downlink transmissions. Both the subscriptions 410 and 420 are supported on a single physical UE device. This configuration is referred to as transmission sharing dual SIM dual active subscriptions (DSDA). It is noted that although the present description is with respect to only two SIMs, the present disclosure contemplates additional SIMs, such as a triple SIM device, a quadruple SIM device, etc.

In the example 400, the first RAT is active for a packet switched (PS) data call on the first subscription 410 (subscription-1) and the second RAT is in an active voice call on the second subscription 420 (subscription-2). For voice traffic on the second RAT, the network allocates traffic time slots for the uplink (UL) transmission (Tx). This slot allocation for the second RAT uplink transmission may repeat for subsequent frames. As a result, the uplink transmission allocation of the second RAT may collide with scheduled transmissions of the packet switched data of the first RAT. In case of a collision, neither transmission can go through.

The example 400 shows that the subscription-1 410 has five time slots 412-419 and the subscription-2 420 has five time slots for two vocoder frames. The first vocoder frame has four time slots 422-428 and the second vocoder frame starts at time slot 429. The remainder is not shown in FIG. 4. As the example 400 shows, the first vocoder frame of the subscription-2 420 has four time slots (i.e., time slots 422-428) overlapping or in collision with the time slots of the subscription-1 410. In FIG. 4, the shaded time slots having ‘X’s represent blanked time slots.

According to one aspect of the present disclosure, instead of blindly giving the voice vocoder frames of subscription-2 420 a higher priority over the packet data time slots of the subscription-1 410, the UE uses a threshold for the number of overlapping time slots within a vocoder frame to determine which subscription is given a higher priority for uplink transmission for the frame period. At least part of the reason for introducing the threshold is because an uplink collision between the first RAT and second RAT can be bursty and therefore it may be desirable to blank an entire vocoder frame.

In this example 400, the threshold is set to 2. Because the first vocoder frame of the subscription-2 420 has 4 time slots overlapping with time slots of the subscription-1, the entire vocoder frame of subscription-2 including time slots 422-428 of the subscription-2 420 is blanked. The blanking allows uplink transmission by the subscription-1 420 to go through during this blanked vocoder frame period.

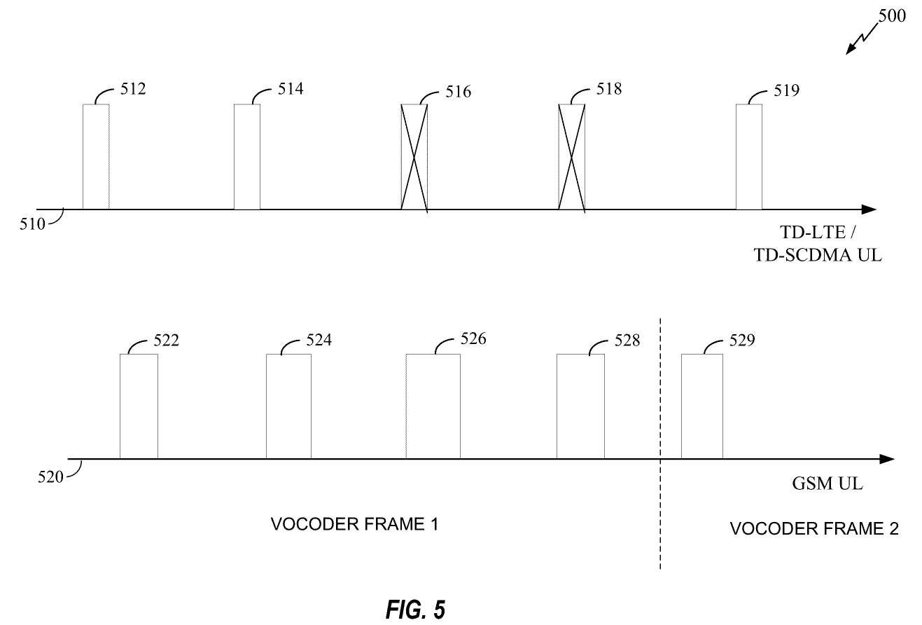

FIG. 5 is a block diagram illustrating an example 500 of blanking packet data time slots. In this example, the number of time slots of the vocoder frame of the second RAT overlapping packet data time slots of the first RAT is less than or equal to the threshold. In FIG. 5, the x-axis represents time. The example 500 shows that subscription-2 520 of the second RAT has two vocoder frames. The first vocoder frame has time slots 522-528 and the second vocoder frame starts at time slot 529. In the example 500, the first vocoder frame of the subscription-2 520 has 2 time slots (i.e., time slots 526-528) overlapping or in collision with the packet data time slots of the subscription-1 510.

In one aspect of the present disclosure, if the number of the overlapping time slots of a vocoder frame is equal to or below a threshold, the overlapping data time slots of subscription-1 510 of the first RAT are blanked. In this example, because the number of time slots of the first vocoder frame of subscription-2 520 overlapping with data time slots of subscription-1 510 is equal to the threshold of 2, the overlapping packet data time slots 516-518 of the subscription-2 520 are blanked. The blanking allows the vocoder frame of subscription-1 510 to go through on uplink transmission. In FIG. 5, the shaded time slots having ‘X’s represent blanked time slots.

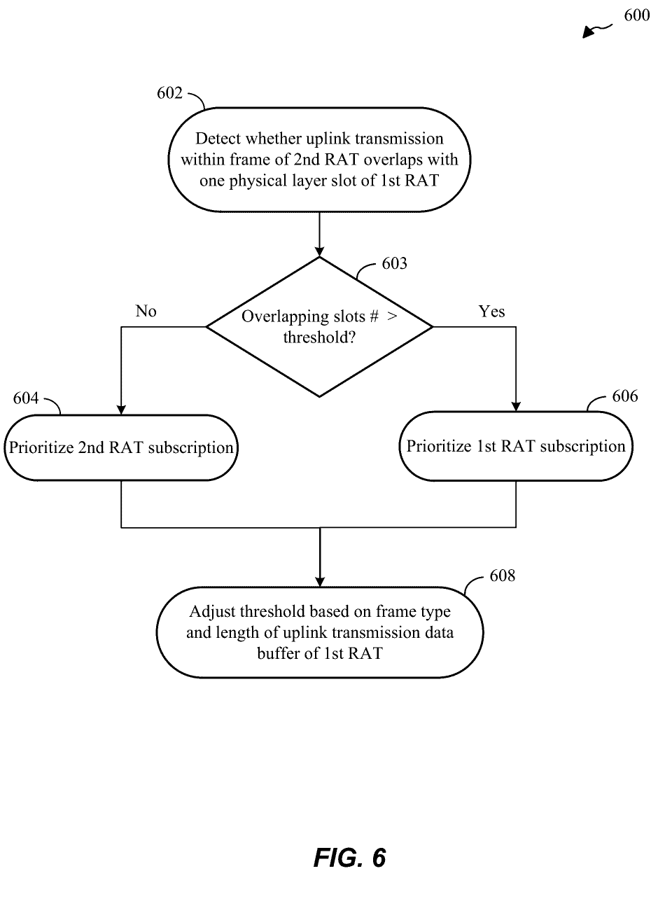

FIG. 6 shows a flow diagram 600 illustrating, as an example, a decision process for sharing a transmitter at a UE by multiple active subscriptions of different RATs. The flow diagram 600 is for illustration purposes only and other alternative aspects of the decision process for sharing a transmitter are certainly possible. The process may be executed on a frame by frame basis.

In one example, a first RAT is TD-LTE or TD-SCDMA and a second RAT is GSM. The LTE subscription may support data applications such as video streaming and web browsing. The GSM subscription may support voice services, which may be more time sensitive than some of the first RAT subscription data such as web browsing. According to one aspect of the present disclosure, the vocoder frame of the second RAT may overlap not only time slots of the first RAT, but also the time slots of a third RAT. The flow diagram 600 may easily be extended to cover a subscription of a third RAT, fourth RAT or beyond.

At block 602, the UE detects whether an uplink transmission within a vocoder frame of the second RAT overlaps at least one physical layer slot of the first RAT. If yes, the UE also determines the number of time slots within the vocoder frame overlapping with packet data time slots of the first RAT. Then at decision block 603, the UE further determines whether the number of overlapping slots is above a threshold. If yes, at block 606, instead of prioritizing the vocoder frame of the second RAT by default, the UE prioritizes the first RAT data time slots to avoid starving the first RAT subscription for an extended period of time. In one example, prioritizing the first RAT data time slots may mean blanking the entire vocoder frame of the second RAT subscription. The blanking effectively allows the first RAT subscription to transmit uplink data while blocking the second RAT subscription for uplink transmission for the frame period.

At block 604, if the number of overlapping slots is not above the threshold, the UE may choose to prioritize the second RAT vocoder frame. This effectively gives a higher priority to or maintains a default higher priority for the second RAT subscription in a voice call. In general, the second RAT, such as GSM, may be used for a voice call, which is more sensitive to a time delay.

At block 608, the UE may adjust the threshold based on a frame type of the vocoder frame of the second RAT, a length of the packet data buffer for uplink transmission of the first RAT, or both. For example, according to one aspect of the present disclosure, a silence indicator (SID) frame may be a vocoder frame type with a low priority, while a control frame or a voice data frame may have a higher priority.

In another aspect of the present disclosure, the threshold may also be based on the length of the packet data buffer for uplink transmission of the first RAT. For example, a long length of the data buffer may indicate there are many uplink data packets of the first RAT waiting to be transmitted. Thus, the first RAT subscription may be less tolerant to further delay and the threshold may be set lower. In comparison, when the length of the packet data buffer is short, the first RAT subscription may be more tolerant to further delay and thus, the threshold may be set higher.

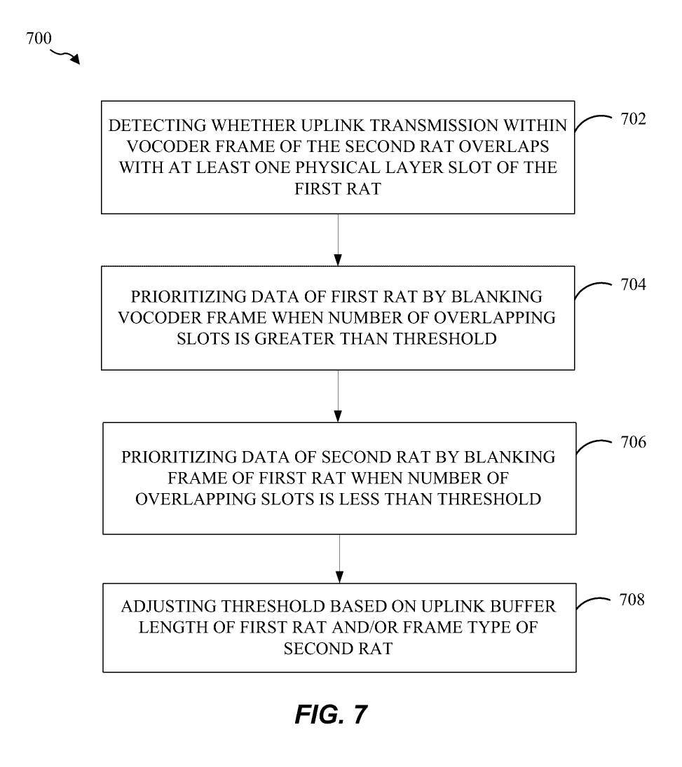

FIG. 7 is a flow diagram illustrating a method 700 for sharing a transmitter for dual active subscriptions at a UE according to one aspect of the present disclosure. The dual active subscriptions is used as an example and the method 700 may be easily extended to cover a subscription of a third RAT or beyond.

At block 702, the UE may detect whether an uplink transmission within a vocoder frame of the second RAT overlaps at least one physical layer slot of the first RAT. If at least one overlapping slot is detected, the UE may further determine the number of overlapping slots within the vocoder frame.

At block 704, the UE may prioritize data of the first RAT by blanking the vocoder frame of the second RAT when the number of overlapping slots with a vocoder frame of the second RAT is above a threshold. Blanking the vocoder frame may include blanking the data of the entire vocoder frame of the second RAT subscription. When the number of overlapping time slots is above the threshold, it may indicate that the time slots of two active subscriptions in conflict reaches a level that impacts the service quality of the first RAT subscription. By default, the time slots of the second RAT, such as GSM, may be given a higher priority because voice traffic in general is favored over packet data traffic. This may cause the first RAT subscription to suffer long delay and worse, even session failure in some cases. Blanking the frame of the second RAT vocoder frame time slots clear the way for the first RAT data transmission for the frame period.

At block 706, the UE may prioritize the data of the second RAT by blanking the time slot(s) of the first RAT that are in conflict with the time slot(s) of the vocoder frame of the second RAT, when the number of overlapping slots is below the threshold.

At block 708, in one aspect of the present disclosure, the UE may adjust the threshold based on an uplink data buffer length of the first RAT, a frame type of the second RAT, or both. The examples of the frame type of the second RAT may include a vocoder frame, a super frame, a control frame, a silence indicator frame, and a data frame, among others. If a frame type of the second RAT, such as a control frame or voice data frame, is more sensitive to time delay, the threshold may be set higher. Or conversely, if the frame type such as a silence indicator frame or a noise frame is less sensitive to time delay, the threshold may be set lower.

In one aspect of the present disclosure, the UE may also adjust the threshold based on the length of the uplink data buffer of the first RAT. A longer buffer means that more uplink data of the first RAT is waiting to be transmitted. Thus, the threshold may be set lower so that the data of the first RAT subscription may receive priority sooner. Conversely, a shorter uplink data buffer of the first RAT means that less uplink data is waiting to be transmitted. Thus, the threshold may be set higher.

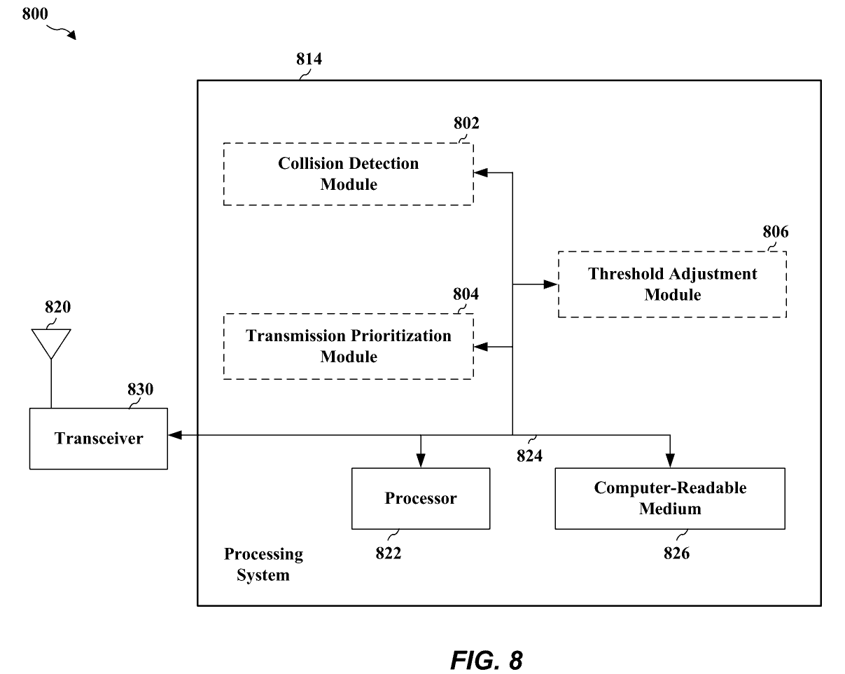

FIG. 8 is a block diagram illustrating an example of a hardware implementation for an apparatus 800 employing a processing system 814 with different modules/means/components for fast return failure handling in a high-speed scenario in an example apparatus according to one aspect of the present disclosure. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 822 the modules 802, 804, 806 and the non-transitory computer-readable medium 826. The bus 824 may also link various other circuits such as timing sources, peripherals, voltage regulators, and power management circuits, which are well known in the art, and therefore, will not be described any further.

The apparatus includes a processing system 814 coupled to a transceiver 830. The transceiver 830 is coupled to one or more antennas 820. The transceiver 830 enables communicating with various other apparatus over a transmission medium. The processing system 814 includes a processor 822 coupled to a non-transitory computer-readable medium 826. The processor 822 is responsible for general processing, including the execution of software stored on the computer-readable medium 826. The software, when executed by the processor 822, causes the processing system 814 to perform the various functions described for any particular apparatus. The computer-readable medium 826 may also be used for storing data that is manipulated by the processor 822 when executing software.

The processing system 814 includes a collision detection module 802 for detecting time slots of a vocoder frame of a first RAT overlapping with time slots of a second RAT. The processing system 814 also includes a shared transmission prioritization module 804 for prioritizing transmission of the first RAT over the second RAT or vice versa, depending on whether the number of overlapping slots in the vocoder frame is above a threshold. The processing system 814 may also include a threshold adjustment module 806 for adjusting the threshold based on parameters such as a frame type of the second RAT and a length of uplink packet data buffer of the first RAT. The modules 802, 804 and 806 may be software modules running in the processor 822, resident/stored in the computer-readable medium 826, one or more hardware modules coupled to the processor 822, or some combination thereof. The processing system 814 may be a component of the UE 350 of FIG. 3 and may include the memory 392, and/or the controller/processor.

In one configuration, an apparatus such as a UE 350 is configured for wireless communication to include means for detecting whether an uplink time slots within a vocoder frame of the second RAT overlaps at least one physical layer slot of the first RA. In one aspect, the detecting means may be the antennas 352, the receiver 354, the channel processor 394, the receive frame processor 360, the receive processor 370, the controller/processor 390, the uplink transmitter sharing module 391, the memory 392, the collision detection module 802, and/or the processing system 814 configured to perform the functions recited by the detecting means. In one configuration, the means and functions correspond to the aforementioned structures. In another aspect, the aforementioned means may be any module or any apparatus configured to perform the functions recited by the detecting means.

The UE 350 is also configured to include means for prioritizing data of the first RAT by blanking a vocoder frame when a number of overlapping time slots within the vocoder frame is above a threshold or prioritizing the data of the second RAT by blanking the time slots of the first RAT when the number of overlapping slots is not above the threshold. In one aspect, the prioritizing means may include the antennas 352, the transmitter 356, the transmit frame processor 382, the transmit processor 380, the controller/processor 390, the uplink transmitter sharing module 391, the memory 392, the transmission prioritization module 804, and/or the processing system 814 configured to perform the functions recited by the prioritizing means. In one configuration, the means and functions correspond to the aforementioned structures. In another aspect, the aforementioned means may be any module or any apparatus configured to perform the functions recited by the prioritizing means.

The UE 350 is also configured to include means for adjusting the threshold based on an uplink buffer length, a frame type, or both. In one aspect, the adjusting means may include the controller/processor 390, uplink transmitter sharing module 391, the memory 392, the threshold adjustment module 806, and/or the processing system 814 configured to perform the functions recited by the adjustment means. In one configuration, the means and functions correspond to the aforementioned structures. In another aspect, the aforementioned means may be a module or any apparatus configured to perform the functions recited by the adjusting means.

Several aspects of a telecommunications system has been presented with reference to LTE or LTE-advanced (LTE-A) (in FDD, TDD, or both modes), 2G/3G RATs such as GSM, TD-SCDMA and CDMA2000, and evolution-data optimized (EV-DO). As those skilled in the art will readily appreciate, various aspects described throughout this disclosure may be extended to other telecommunication systems, network architectures and communication standards, including those with high throughput and low latency such as 4G systems, 5G systems and beyond. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

It is also to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication in a multi subscriber identification module (SIM) user equipment (UE) with multiple active subscriptions sharing a transmit (TX) chain among at least a first radio access technology (RAT) and a second RAT, comprising:
detecting whether an uplink transmission within a frame of the second RAT overlaps at least one time slot of the first RAT; and
prioritizing data of the first RAT by blanking the frame of the second RAT when a number of overlapping slots is above a threshold.

2. The method of claim 1, in which the frame comprises a vocoder frame.

3. The method of claim 1, further comprising prioritizing the frame of the second RAT by blanking time slots of the first RAT when the number of overlapping slots is less than the threshold.

4. The method of claim 1, further comprising adjusting the threshold based at least in part on a frame type of the second RAT.

5. The method of claim 1, further comprising adjusting the threshold based at least in part on an uplink data buffer length of the first RAT.

6. The method of claim 1, in which the first RAT comprises one of long term evolution (LTE), time-division (TD) LTE and TD-code division multiple access (CDMA) and the second RAT comprises one of global system for mobile communications (GSM) and universal mobile telecommunications system (UMTS).

7. An apparatus for wireless communication having multiple active subscriptions sharing a transmit (TX) chain among at least a first radio access technology (RAT) and a second RAT, comprising:
a memory; and
at least one processor coupled to the memory and configured:
to detect whether an uplink transmission within a frame of the second RAT overlaps at least one time slot of the first RAT; and
to prioritize data of the first RAT by blanking the frame of the second RAT when a number of overlapping slots is above a threshold.

8. The apparatus of claim 7, in which the frame comprises a vocoder frame.

9. The apparatus of claim 7, in which the at least one processor is further configured to prioritize the frame of the second RAT by blanking time slots of the first RAT when the number of overlapping slots is less than the threshold.

10. The apparatus of claim 7, in which the at least one processor is further configured to adjust the threshold based at least in part on a frame type of the second RAT.

11. The apparatus of claim 7, in which the at least one processor is further configured to adjust the threshold based at least in part on an uplink data buffer length of the first RAT.

12. The apparatus of claim 7, in which the first RAT comprises one of long term evolution (LTE), time-division (TD) LTE and TD-code division multiple access (CDMA) and the second RAT comprises one of global system for mobile communications (GSM) and universal mobile telecommunications system (UMTS).

13. An apparatus for wireless communication having multiple active subscriptions sharing a transmit (TX) chain among at least a first radio access technology (RAT) and a second RAT, comprising:
means for detecting whether an uplink transmission within a frame of the second RAT overlaps at least one time slot of the first RAT; and
means for prioritizing data of the first RAT by blanking the frame of the second RAT when a number of overlapping slots is above a threshold.

14. The apparatus of claim 13, in which the frame comprises a vocoder frame.

15. The apparatus of claim 13, further comprising means for prioritizing the frame of the second RAT by blanking time slots of the first RAT when the number of overlapping slots is less than the threshold.

16. The apparatus of claim 13, further comprising means for adjusting the threshold based at least in part on a frame type of the second RAT.

17. The apparatus of claim 13, further comprising means for adjusting the threshold based at least in part on an uplink data buffer length of the first RAT.

18. The apparatus of claim 13, in which the first RAT comprises one of long term evolution (LTE), time-division (TD) LTE and TD-code division multiple access (CDMA) and the second RAT comprises one of global system for mobile communications (GSM) and universal mobile telecommunications system (UMTS).

19. A computer program product for wireless communication in a multi subscriber identification module (SIM) user equipment (UE) with multiple active subscriptions sharing a transmit (TX) chain among at least a first radio access technology (RAT) and a second RAT, comprising:
a non-transitory computer readable medium having encoded thereon program code, the program code comprising:
program code to detect whether an uplink transmission within a frame of the second RAT overlaps at least one time slot of the first RAT; and
program code to prioritize data of the first RAT by blanking the frame of the second RAT when a number of overlapping slots is above a threshold.

20. The computer program product of claim 19, in which the frame comprises a vocoder frame.

21. The computer program product of claim 19, further comprising program code to prioritize the frame of the second RAT by blanking time slots of the first RAT when the number of overlapping slots is less than the threshold.

22. The computer program product of claim 19, further comprising program code to adjust the threshold based at least in part on a frame type of the second RAT.

23. The computer program product of claim 19, further comprising program code to adjust the threshold based at least in part on an uplink data buffer length of the first RAT.

24. The computer program product of claim 19, in which the first RAT comprises one of long term evolution (LTE), time-division (TD) LTE and TD-code division multiple access (CDMA) and the second RAT comprises one of global system for mobile communications (GSM) and universal mobile telecommunications system (UMTS).
